(19) United States
(12) Patent Application Publication
(10) Pub. No.: US 2026/0169311 A1
(43) Pub. Date: Jun. 18, 2026

(54) AUGMENTED REALITY GLASSES AND IMAGE ACQUISITION EQUIPMENT

(71) Applicant: AAC Microtech (Changzhou) Co., Ltd., Changzhou City, Jiangsu (CN)

(72) Inventors: Lubin Mao, Changzhou (CN); Wei Song, Changzhou (CN)

(21) Appl. No.: 19/307,018

(22) Filed: Aug. 21, 2025

Related U.S. Application Data
(63) Continuation of application No. PCT/CN2024/139480, filed on Dec. 16, 2024.

(51) Int. Cl. G02C 7/16; G02B 27/01

(52) U.S. Cl. CPC G02C 7/16; G02B 27/0172; G02B 27/0176; G02B 2027/0145; G02B 2027/0178

(57) ABSTRACT

Augmented reality glasses and image acquisition equipment are provided. The augmented reality glasses include glasses legs, a glasses frame connected to the glasses legs, and eyeglasses and a camera that are mounted on the glasses frame, the augmented reality glasses further include: a blocking assembly mounted on the glasses frame and a driving mechanism for driving the blocking assembly to move. The driving mechanism is in transmission connection to the blocking assembly. The driving mechanism is configured to drive the blocking assembly to move between a blocking position and an exposing position. The augmented reality glasses and image acquisition equipment of the embodiments of the present invention expose a camera when photo taking is required and block the camera when photo taking is not required. This can protect the camera and meet a privacy requirement of a user.

### CROSS-REFERENCE TO RELATED APPLICATIONS

This application is a continuation of International Application No. PCT/CN2024/139480, filed on Dec. 16, 2024, the entire content of which is incorporated herein by reference.

### TECHNICAL FIELD

Embodiments of the present invention belong to the technical field of augmented reality glasses, and in particular to, augmented reality glasses and image acquisition equipment.

### BACKGROUND

With the development of virtual reality technology, augmented reality (AR) glasses are increasingly popular and have more functions. Correspondingly, the AR glasses can be provided with different components, such as a camera, to meet usage requirements.

In the related art, the camera on the AR glasses is usually mounted at a middle position or at two ends of a glasses frame, and the camera is exposed to ensure smooth light transmission and normal image capturing. For this type of AR glasses with the exposed camera, based on relevant market research, in a communication process of two parties, if one party wears the AR glasses with the camera while communicating with the other party, the other party may feel very uncomfortable. As a result, the user experience is poor, and users may question about the privacy protection of the glasses. Moreover, it is easy to damage the exposed camera.

### SUMMARY

The embodiments of the present invention aim to solve at least one of the technical problems in the existing art, and provide augmented reality glasses and image acquisition equipment.

In the first aspect, the present invention provides augmented reality glasses, including glasses legs, a glasses frame connected to the glasses legs, and eyeglasses and a camera that are mounted on the glasses frame, the augmented reality glasses further include: a blocking assembly mounted on the glasses frame and a driving mechanism for driving the blocking assembly to move; the driving mechanism is in transmission connection to the blocking assembly; the driving mechanism is configured to drive the blocking assembly to move between a blocking position and an exposing position; when the blocking assembly is located in the blocking position, the camera is blocked; and when the blocking assembly is located in the exposing position, the camera is exposed.

Optionally, the glasses frame includes a first glasses frame and a second glasses frame assembled on the first glasses frame; and an accommodating space for accommodating the driving mechanism, the blocking assembly, and the camera is arranged between the first glasses frame and the second glasses frame.

Optionally, the blocking assembly includes a connector and a blocking member; the connector includes a first end and a second end opposite to the first end; the first end of the connector is in transmission connection to the driving mechanism; and the second end of the connector is fixedly connected to the blocking member.

Optionally, the driving mechanism includes a driving motor; the blocking member is a cover plate; the driving motor includes an output shaft; the output shaft is fixedly connected to the first end of the connector to drive the connector to rotate; and the second end of the connector is fixedly connected to the cover plate to drive the cover plate to flip.

Optionally, a mounting slot and a through hole communicated with the mounting slot are provided in one side of the second glasses frame facing away from the first glasses frame; the through hole corresponds to a position of the camera; and the blocking member is arranged inside the mounting slot.

Optionally, the augmented reality glasses further include a control assembly arranged at each glasses leg; the control assembly is electrically connected to the driving mechanism; and the control assembly is configured to control the driving mechanism based on a received control instruction.

Optionally, the control assembly includes a touch module and a control module which are electrically connected to each other; and the control module is configured to control the driving mechanism based on a touch state of the touch module, to cause the blocking assembly to move between the blocking position and the exposing position.

Optionally, each glasses leg is provided with an accommodating slot for accommodating the control module; and the touch module is arranged on an outer surface of the glasses leg.

Optionally, the augmented reality glasses include two cameras, two driving mechanisms, and two blocking assemblies that are symmetrically arranged on the glasses frame; and each camera corresponds to one driving mechanism and one blocking assembly.

In the second aspect, the present invention also provides image acquisition equipment, which employs the augmented reality glasses described above.

The augmented reality glasses and image acquisition equipment of the embodiments of the present invention expose a camera when photo taking is required and block the camera when photo taking is not required. This can protect the camera and meet a privacy requirement of a user.

### BRIEF DESCRIPTION OF THE DRAWINGS

FIG. 1 is a schematic diagram of an entire structure of augmented reality glasses according to an embodiment of the present invention;

FIG. 2 is an exploded view of a three-dimensional structure of augmented reality glasses according to an embodiment of the present invention;

FIG. 3 is an enlarged structural view of cooperation between a blocking assembly and a driving mechanism according to this embodiment of the present invention; and

FIG. 4 is a schematic block diagram of a control assembly according to this embodiment of the present invention.

### DETAILED DESCRIPTION OF THE EMBODIMENTS

The present invention is further described below in detail in combination with the accompanying drawings and embodiments.

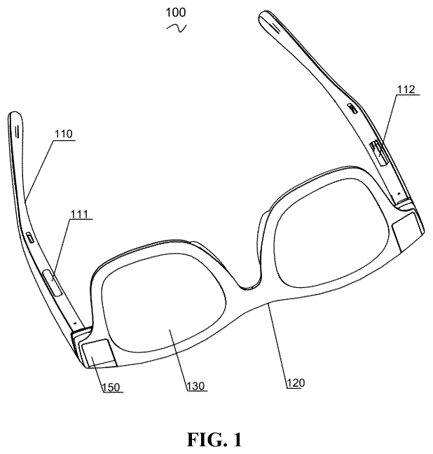

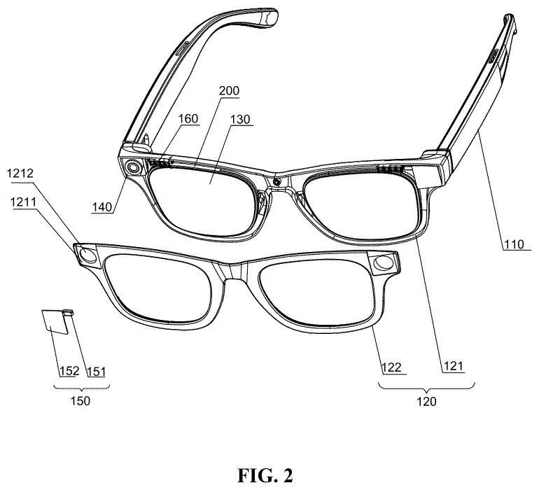

As shown in FIG. 1 and FIG. 2, augmented reality glasses 100 includes glasses legs 110, a glasses frame 120 connected to the glasses legs 110, and eyeglasses 130 and a camera 140 that are mounted on the glasses frame 120. The augmented reality glasses 100 further include: a blocking assembly 150 mounted on the glasses frame 120 and a driving mechanism 160 for driving the blocking assembly 150 to move. The driving mechanism 160 is in transmission connection to the blocking assembly 150. The driving mechanism 160 is configured to drive the blocking assembly 150 to move between a blocking position and an exposing position. When the blocking assembly 150 is located in the blocking position, the blocking assembly 150 blocks the camera 140. When the blocking assembly 150 is located in the blocking position, the blocking assembly 150 exposes the camera 140.

Specifically, as shown in FIG. 1 and FIG. 2, the glasses legs 110 can be worn on a user. The eyeglasses 130 are arranged inside a center region of the glasses frame 120. The eyeglasses 130 are electrically connected to the camera 140 for displaying content acquired by the camera 140.

In a specific example, as shown in FIG. 2, the augmented reality glasses 100 include two cameras 140, two driving mechanisms 160, and two blocking assemblies 150 that are symmetrically arranged on the glasses frame 120. Each camera 140 corresponds to one driving mechanism 160 and one blocking assembly 150. Specifically, a group of corresponding camera 140, blocking assembly 150, and driving mechanism 160 is arranged on each of two sides of the glasses frame 120. Certainly, this embodiment is only for an illustration purpose. A plurality of groups of corresponding cameras 140, blocking assemblies 150, and driving mechanisms 160 can also be provided. A quantity of groups provided and positions for each group can be selected as required. This embodiment does not impose specific restrictions on this.

The blocking assembly 150 is mounted on the glasses frame 120. The driving mechanism 160 can be mounted on either the glasses frame 120 or on the glasses legs 110. Different mounting positions can be selected according to an actual application. This embodiment takes an example for explanation, in which the driving mechanism 160 is mounted on the glasses frame 120. The driving mechanism 160 is connected to the blocking assembly 150 and is configured to drive the blocking assembly 150 to move between the blocking position and the exposing position. When the blocking assembly 150 is in the blocking position, the blocking assembly 150 can block a camera lens of the camera 140 for protection. When the blocking assembly 150 is in the exposing position, the blocking assembly 150 can expose the camera lens of the camera 140 for image acquisition.

The augmented reality glasses of this embodiment of the present invention can expose the camera when taking photos to obtain images, without affecting a normal photo taking function. The camera can be blocked at ordinary time, for example, if photo taking is not required, so that the camera can be protected, and a privacy requirement of a user can be met.

Exemplarily, as shown in FIG. 1 and FIG. 2, the glasses frame 120 includes a first glasses frame 121 and a second glasses frame 122 assembled on the first glasses frame 121. An accommodating space 200 for accommodating the driving mechanism 160, the blocking assembly 150, and the camera 140 is arranged between the first glasses frame 121 and the second glasses frame 122.

Specifically, as shown in FIG. 2, the accommodating space 200 for accommodating the driving mechanism 160, the blocking assembly 150, and the camera 140 is arranged between the first frame 121 and the second frame 122. The driving mechanism 160, the blocking assembly 150, and the camera 140 are arranged inside the accommodating space 200, so that the overall glasses frame 120 is more concise, which can improve the simplicity and storage performance of the augmented reality glasses and reduce the overall occupancy rate.

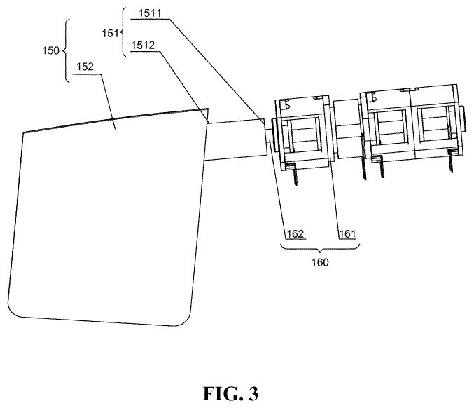

Exemplarily, as shown in FIG. 2 and FIG. 3, the blocking assembly 150 includes a connector 151 and a blocking member 152. The connector 151 includes a first end 1511 and a second end 1512 opposite to the first end 1511. The first end 1511 of the connector 151 is in transmission connection to the driving mechanism 160, and the second end 1512 of the connector 151 is fixedly connected to the blocking member 152.

In a specific example, as shown in FIG. 2 and FIG. 3, the driving mechanism 160 includes a driving motor 161, and the driving motor 161 is provided with an output shaft 162. The blocking member 152 is a cover plate. The output shaft 162 of the driving motor 161 is fixedly connected to the first end 1511 of the connector 151 to drive the connector 151 to rotate; and the second end 1512 of the connector 151 is fixedly connected to the cover plate to drive the cover plate to flip.

Specifically, as shown in FIG. 2 and FIG. 3, when the blocking assembly 150 is in the blocking position, the cover plate is located on a front side of the camera 140 and can block a camera lens of the camera 140 for protection. When the camera 140 needs to be exposed, the driving motor 161 works and drives the connector 151 to rotate through the output shaft 162. The connector 151 drives the cover plate to flip upwards until the camera lens of the camera 140 is exposed. In this case, the blocking assembly 150 is in the exposing position. An angle at which the cover plate flips upwards can be 90 degrees, 180 degrees, and the like, as long as the camera 140 can be fully exposed. When the camera 140 does not need to be exposed, the driving motor 161 works and drives the connector 151 to rotate counterclockwise through the output shaft 162. The connector 151 drives the cover plate to flip downwards until the camera lens of the camera 140 is blocked. In this case, the blocking assembly 150 returns to the blocking position.

In another specific example, the driving mechanism 160 includes an expansion and retraction mechanism. A telescopic end of the expansion and retraction mechanism is fixedly connected to the first end 1511 of the connector 151, and the second end 1512 of the connector 151 is fixedly connected to the blocking member 152. The expansion and retraction mechanism can drive the blocking member 152 to extend towards an outer side through the connector 151 until it extends outwards to the exposing position to completely expose the camera 140. The expansion and retraction mechanism can also drive the blocking member 152 to retract from the outer side through the connector 151 until it retracts to the blocking position to completely block the camera 140.

Exemplarily, as shown in FIG. 2, a mounting slot 1211 and a through hole 1212 communicated with the mounting slot 1211 are provided in one side of the second glasses frame 122 facing away from the first glasses frame 121. The through hole 1212 corresponds to a position of the camera 140. The blocking member 152 is arranged inside the mounting slot 1211.

Exemplarily, as shown in FIG. 1 to FIG. 4, the augmented reality glasses 100 further include a control assembly 111 arranged on each glasses leg 110. The control assembly 111 is electrically connected to the driving mechanism 160. The control assembly 111 is configured to control the driving mechanism 160 based on a received control instruction.

Specifically, as shown in FIG. 1 to FIG. 4, each glasses leg 110 is further provided with the control assembly 111, and the control assembly 111 is electrically connected to the driving mechanism 160. The control assembly 111 is configured to: receive the control instruction and control the driving mechanism 160 to perform related work through the corresponding control instruction.

Further, as shown in FIG. 1 to FIG. 4, the control assembly 111 includes a touch module 1111 and a control module 1112 that are electrically connected to each other. The control module 1112 is configured to control the driving mechanism 160 based on a touch state of the touch module 1111, to cause the blocking assembly 150 to move between the blocking position and the exposing position. For example, the touch module 1111 can be set to be in a button form. Different control instructions are transmitted to the control module 1112 through different pressing states of the button, and the driving mechanism 160 is further controlled through the control module 1112. If the button is pressed once, the driving mechanism 160 drives the blocking assembly 150 to the exposing position. The button is repeatedly pressed twice continuously and quickly, and the driving mechanism 160 drives the blocking assembly 150 to the blocking position. The set control module can cooperate with the driving mechanism to achieve the movement of the blocking assembly between the exposing position and the blocking position, thereby increasing the degree of automation. In a specific example, the control module can be set as a button touch motor. Certainly, the control module can also be set in another form, as long as it can cooperate with the driving mechanism to control the blocking assembly. This embodiment does not impose specific restrictions on this.

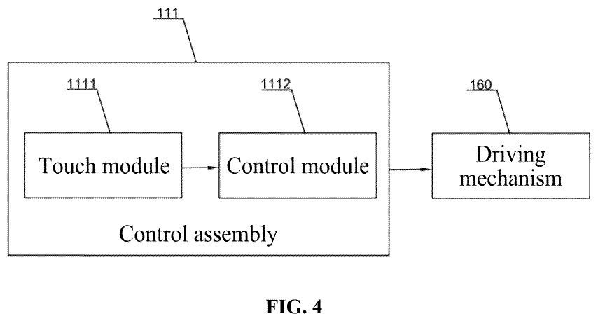

Exemplarily, as shown in FIG. 1 and FIG. 4, each glasses leg 110 is provided with an accommodating slot 112 for accommodating the control module 1112, and the touch module 1111 is arranged on an outer surface of the glasses leg 110. In a specific example, each glasses leg 110 is provided with an accommodating slot 112, and the control module 1112 is placed inside the accommodating slot 112. One end of the touch module 1111 is connected to the control module 1112 inside the accommodating slot 112, and the other end is located on an outer surface of the glasses leg 110 and is connected to the glasses leg 110. This setting not only facilitates user control, but also further increases the degree of integration of the augmented reality glasses.

In another aspect, an embodiment of the present invention provides image acquisition equipment. The image acquisition equipment employs the foregoing augmented reality glasses. For the specific structure of the augmented reality glasses, refer to the relevant descriptions in the previous text and will not be further elaborated here.

The image acquisition equipment of this embodiment of the present invention can block the camera when photo taking is not required, thereby ensuring the overall smoothness of a machine body and meeting a privacy requirement. When photo taking is required, the camera is exposed, without affecting a normal photo taking function.

As described above, one or more embodiments are provided in conjunction with the detailed description, The specific implementation of the present invention is not confirmed to be limited to that the description is similar to or similar to the method, the structure and the like of the present invention, or a plurality of technical deductions or substitutions are made on the premise of the conception of the present invention to be regarded as the protection of the present invention.

What is claimed is:

1. Augmented reality glasses, comprising glasses legs, a glasses frame connected to the glasses legs, and eyeglasses and a camera that are mounted on the glasses frame, wherein the augmented reality glasses further comprise: a blocking assembly mounted on the glasses frame and a driving mechanism for driving the blocking assembly to move; the driving mechanism is in transmission connection to the blocking assembly;
the driving mechanism is configured to drive the blocking assembly to move between a blocking position and an exposing position; when the blocking assembly is located in the blocking position, the camera is blocked; and when the blocking assembly is located in the exposing position, the camera is exposed.

2. The augmented reality glasses according to claim 1, wherein the glasses frame comprises a first glasses frame and a second glasses frame assembled on the first glasses frame; and an accommodating space for accommodating the driving mechanism, the blocking assembly, and the camera is arranged between the first glasses frame and the second glasses frame.

3. The augmented reality glasses according to claim 2, wherein the blocking assembly comprises a connector and a blocking member;
the connector comprises a first end and a second end opposite to the first end; the first end of the connector is in transmission connection to the driving mechanism; and the second end of the connector is fixedly connected to the blocking member.

4. The augmented reality glasses according to claim 3, wherein the driving mechanism comprises a driving motor; the blocking member is a cover plate;
the driving motor comprises an output shaft; the output shaft is fixedly connected to the first end of the connector to drive the connector to rotate; and the second end of the connector is fixedly connected to the cover plate to drive the cover plate to flip.

5. The augmented reality glasses according to claim 3, wherein a mounting slot and a through hole communicated with the mounting slot are provided in one side of the second glasses frame facing away from the first glasses frame; the through hole corresponds to a position of the camera; and the blocking member is arranged inside the mounting slot.

6. The augmented reality glasses according to claim 1, wherein the augmented reality glasses further comprise a control assembly arranged at each glasses leg;
the control assembly is electrically connected to the driving mechanism; and the control assembly is configured to control the driving mechanism based on a received control instruction.

7. The augmented reality glasses according to claim 6, wherein the control assembly comprises a touch module and a control module which are electrically connected to each other; and
the control module is configured to control the driving mechanism based on a touch state of the touch module, to cause the blocking assembly to move between the blocking position and the exposing position.

8. The augmented reality glasses according to claim 7, wherein each glasses leg is provided with an accommodating slot for accommodating the control module; and the touch module is arranged on an outer surface of the glasses leg.

9. The augmented reality glasses according to claim 1, wherein the augmented reality glasses comprise two cameras, two driving mechanisms, and two blocking assemblies that are symmetrically arranged on the glasses frame; and
each camera corresponds to one driving mechanism and one blocking assembly.

10. Image acquisition equipment, which employs the augmented reality glasses according to claim 1.
